(19) United States
(12) Patent Application Publication
(10) Pub. No.: US 2004/0059647 A1
(43) Pub. Date: Mar. 25, 2004

(54) Remote materials management system and method

(76) Inventor: Frederick J. Hudson, West Chester, PA (US)

Correspondence Address: Thomas J. McWilliams, REED SMITH LLP, 2500 One Liberty Place, 1650 Market Street, Philadelphia, PA, 19103-7301, US

(21) Appl. No.: 10/373,296

(22) Filed: Feb. 24, 2003

Related U.S. Application Data
(60) Provisional application No. 60/358,784, filed on Feb. 22, 2002.

(51) Int. Cl. G06F 17/60

(52) U.S. Cl. 705/28; 705/29

(57) ABSTRACT

A materials management system, and a method of controlling a materials management flow including at least one inventoried item, are disclosed. The materials management system may include a remote operation center that provides a coordination of at least one portion of the materials management system, and that receives at least one attribute of at least one material flow item in the at least one portion of the materials management system, and at least one receiving station that transmits the at least one attribute to the remote operation center, and that receives the at least one update attribute from the remote operation center, over an external interconnection. The method includes the steps of scanning the at least one inventoried item upon entry into the materials management system at a first local receiving station, scanning the at least one inventoried item at an at least one secondary receiving station prior to delivery of the item, scanning the at least one inventoried item at at least one tertiary receiving station upon delivery of the item, scanning the at least one least one tertiary receiving station upon delivery of the item, and reconciling placement of the item at at least one of the at least one secondary receiving station and the at least one tertiary receiving station at a remote operation center externally connected to the first local receiving station, the at least one secondary receiving station, and the at least one tertiary receiving station.

### CROSS-REFERENCE TO RELATED APPLICATIONS

This application claims priority to U.S. Provisional Application No. 60/358,784, filed Feb. 22, 2002, and U.S. patent application Serial No.10/074,237, filed Feb. 12, 2002.

### STATEMENT REGARDING FEDERALLY SPONSORED RESEARCH OR DEVELOPMENT

Not Applicable.

### BACKGROUND OF THE INVENTION

1. Field of the Invention

This invention relates primarily to the field of control systems, and, more particularly, to the field of control wherein tracking and reconciliation are desired, and, yet more particularly, to the field of materials management including tracking and reconciliation using an external network.

2. Description of Related Art

Historically, the need has arisen for businesses to control and monitor material flow items from a given point until delivery. This need is present in the business cycle from a time-period just prior to ordering through delivery, receipt, and storage or use. The need for materials management arises from the marketplace, wherein the market participants seek to gain a competitive edge. Also, it is undesirable for businesses to spend time on materials management issues rather than concentrating on core areas of business expertise. In addition, speed and accuracy are important to maintain a competitive advantage. In some situations it is necessary for businesses to evidence a quick response wherein the product being delivered has, for example, a finite lifetime given the conditions present during shipment. In response to this need, among others, materials management systems have been developed. Previous solutions have included, for example, bar coding, and tracking that the bar code has been received at a destination. However, the materials management systems presently employed have historically failed to provide remote coordination and reconciliation of material flow items contained therein, thus evidencing a disadvantage of inefficiency and decreased reliability.

Therefore, the need exists for a materials management system that allows for reconciliation of delivery, and that provides remote access. In response to this need, the present invention provides an efficient, easily interfaced, and modular material flow management system. In addition, reconciliation of the delivery in this materials management system may provide the added benefit of verifying that all items for a given destination have been delivered, or that an item for delivery is delivered to a different destination. This type of reconciliation increases both efficiency and reliability. Efficiency is increased because the need for repeated checking or repeated counting of boxes is negated. Reliability is increased because the system alerts the user of an attempted incorrect delivery, and alternatively may alert to a missed delivery for a given destination.

### BRIEF SUMMARY OF THE INVENTION

The present invention includes a materials management system. The materials management system may include a remote operation center that provides coordination of at least one portion of the materials management system, and that receives at least one attribute of at least one material flow item in the at least one portion of the materials management system, and at least one receiving station that transmits the at least one attribute to the remote operation center, and that receives the at least one update attribute from the remote operation center, over an external interconnection. The remote operation center preferably updates the at least one attribute to at least one updated attribute to formulate the coordination within the materials management system. The at least one attribute and the at least one updated attribute are preferably reconciled at the receiving station by the coordination.

The present invention additionally includes a method of controlling a materials management system including at least one material flow item. The method includes the steps of scanning the at least one material flow item upon entry into the materials management system at a first local receiving station, scanning the at least one material flow item at an at least one secondary receiving station prior to delivery of the item, scanning the at least one material flow item at the at least one tertiary receiving station upon delivery of the item, scanning the at least one least one tertiary receiving station upon delivery of the item, and reconciling placement of the item at the at least one of the at least one secondary receiving station and the at least one tertiary receiving station at a remote operation center externally connected to the first local receiving station, the at least one secondary receiving station, and the at least one tertiary receiving station.

The present invention solves a need in the prior art in that it provides a materials management system that allows for reconciliation of delivery with remote access, in an efficient, easily interfaced, and modular materials management system.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical control system. Those of ordinary skill in the art will recognize that other elements are desirable and/or required in order to implement the present invention. However, because such elements are well known in the art, and because they do not facilitate a better understanding of the present invention, a discussion of such elements is not provided herein.

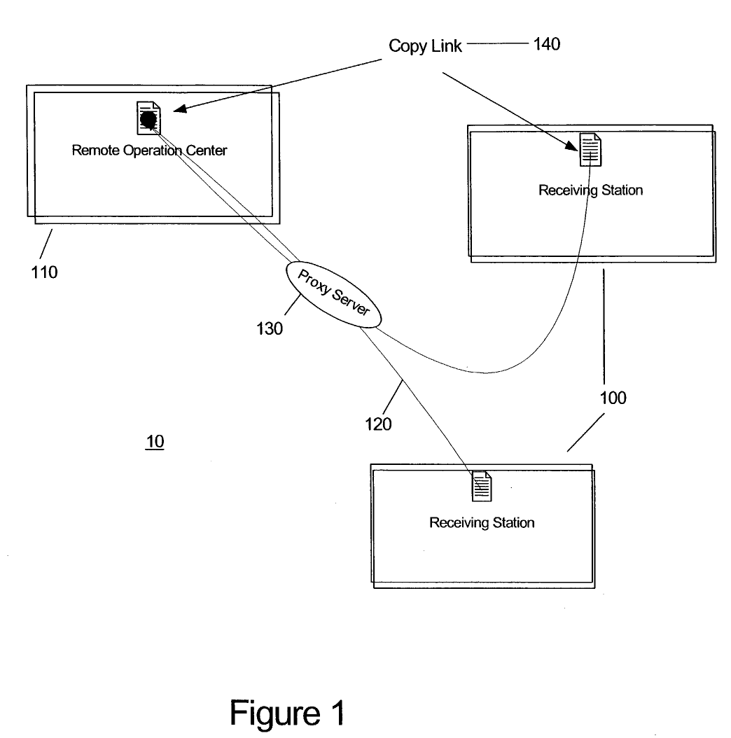

FIG. 1 is a block diagram illustrating a materials management system 10 in accordance with the present invention. The system of the present invention is employed to track at least one item, or package, through the materials management system process of a local site associated with at least one receiving station 100. The system 10 includes at least two receiving stations 100, a remote operation center 110, and an external network connection 120 between the at least two receiving stations 100 and the remote operation center 110. The present invention may additionally include at least one proxy server 130 that controls data flow between at least one receiving station 100 and the external network connection 120, and/or between the at least one external network connection 120 and the remote operation center 110.

The remote operation center 110 serves as the coordinator of the materials management system 10, and receives, interprets, correlates, and transmits data within the materials management system 10. The remote operation center 110 is preferably accessible from any communicative connection with the external network connection 120, using, but not limited to, a PC, PDA, or the like, having internet, extranet, or intranet access to the external network connection 120. The remote operation center 110 receives attributes associated with items, destinations, or other elements necessary for materials management, from other aspects of the materials management system 10, receives and/or generates updates to the attributes, and transmits attributes and updates to the at least two receiving stations 100 upon request from the at least two receiving station 100. An attribute is herein defined as an object or information item, such as a programmable object, associated with, or belonging to, a specific location, item, office, or person, and is, in particular, capable of at least assisting in the unique identification of that item with which that attribute is associated. Thus, attributes include pertinent information that allows, for example, for the categorization of an item, and that allows for the item to be uniquely identified for tracking purposes. Attributes include, but are not limited to, color, shape, size, addressee, status, a signatures record of what, when, and where parties signed for the item, present location of the item, desired delivery destination, contents, and/or weight, for example. In so assigning and identifying by attributes, the remote operation center 110 formulates a coordinated effort within the materials management system 10.

The remote operation center 110 coordinates the efforts at the local site between and among the at least two receiving stations 100, which receiving stations may include, for example, at least one destination site or station, at least one delivery method station, and/or at least one docking station. For example, in a coordinated system, items with similar destinations may be grouped together by the remote operation center 110 for placement onto the same truck, i.e. the same delivery station, for delivery to at least one of the at least one destination stations. Similar destinations may be grouped by the remote operation center 110 so that one truck, or a single conveyer line, for example, can efficiently service similar destination receiving stations, or similar products. In so doing, the materials management system 10 may take into account certain attributes, including but not limited to, the number of items, the weight of the items, and the types of items, for example.

For example, in an exemplary embodiment, it may be desirable that a given type of item, such as items having the attribute “perishable”, may all be delivered using the same methodology, i.e. the same receiving station in the form of a delivery station, such as a refrigerated truck, within, for example, two hours of receipt at a receiving station 100. Perishable goods may include items that must be used within a certain time frame, to goods that must be stored within a predetermined time frame, which conditions are often not met by delivery methodologies of the prior art. In the present invention, for example, perishable is thus defined within the items attributes, thereby providing information to the remote operation center 110 to enable prioritization of the perishable items within a given delivery route. Other types of goods in this exemplary embodiment might require special tools for delivery, such as a forklift, and these special tools would additionally preferably be defined within the attributes of a given item. Items that require a forklift for delivery might be coordinated by the remote operation center 110, overriding other conditions, such coordination for delivery along a common route, such that all goods requiring a forklift for delivery are all delivered from the same truck having a forklift, thereby improving efficiency with respect to delivery requirements.

The remote operation center 110 may additionally provide for a copy link 140 with legacy, or other local, systems of a local site. For example, the copy link 140 may provide a direct link to real-time operations of the client. Using the copy link 140, client web browser page(s) or other methodologies employed to enter data prior to the installation of the materials management system 10, or to formulate commands for use in the materials management system 10, may be coupled to the materials management system 10 via the copy link 140. Thereby, a single user action may be employed to copy and paste information from the local site into the materials management system 10. For example, an operator may highlight relevant attributes within the legacy at the first receiving station 100 regarding a given received item. The operator may hit a “submit” button, for example, which may automatically copy all highlighted attribute information to the attribute record of that item at the remote operation center 110 using the copy link 140.

In addition to the remote operation center 110, the materials management system 10 also preferably includes at least one receiving station 100 serving as a localized control center. A receiving station 100 may, for example, be a remote scanner attached to an electronic device that can communicate with a device, that can store, retrieve and process data, or the receiving station 100 may be a PDA device having a modem enabled to communicate with a receiver that communicates with an electronic device that can store, retrieve, and process data, or the receiving station 100. Each receiving station 100 is preferably capable of receiving and transmitting tracking data to and from the remote operation center 110. The first receiving station 100 at the local site may be, for example, a loading dock at which all incoming items are received at the local site. The first receiving station 100 at the local site may communicate to the remote operation center 110 whether the received item has a pre-existing barcode, such as from the courier that delivered the item, and, if a pre-existing barcode is present, the attributes are preferably transmitted as being associated with the pre-existing barcode. If a pre-existing barcode is not present, the remote operation center 110 preferably generates a barcode tracking number, and sends this tracking number to the first receiving station 100 for printing onto a barcode attachment at the first receiving station 100 for placement onto the received item.

A final receiving station 100 may be, for example, a final delivery point, or may be a hand-off point, either to a carrier that will provide for final delivery, or to a third party. If the requestor of an item did not to wish to wait for an item to be delivered, but instead decided to pick up the item, the knowledge of the item whereabouts in the materials management system 10 could be jeopardized. In this instance, when the third-party comes to claim the item from within the materials management system 10, the item is scanned and manually entered as “claimed” from a given place at a given time by the third-party, thereby updating the status attribute of that item to “third party hand-off”.

One or more receiving stations 100 in the present invention may be PDAs, rather than, for example, PCs. For example, wireless modems having radio transceivers therein may be mounted in warehouse ceilings in order to receive scanned information via radio communication from the PDA receiving station 100, such as within a plant or factory, and in order to forward the information received from the PDA receiving station 100 to the remote operation center 110.

Additionally, the materials management system 10 may thus include transmissions from a PDA receiving station 100 modem, such as packet transmissions via the PDA modem, or may include a batching of all information at the PDA for later download to the remote operation center 110. A packet is a message portion transmitted over a packet-switching network. The packet preferably contains the destination address in addition to data, thereby allowing messages to be divided into packets before sending, thus leading to improved data flow efficiencies and robustness. Batching techniques employed in the present invention may be based on a circuit-switching technology, in which a dedicated line is allocated for transmission between two parties. Circuit-switching is ideal when data must be transmitted quickly and must arrive in the same order in which it is sent. However, the batching of the instant invention may include a data line connection between the PDA and the remote operation center 110, such as by a docking of the PDA at a receiving station 100 having a connection to the remote operation center 110.

Transmission and reception of data from each receiving station 100 to the remote operation center 110 regarding received items may occur in real-time, or may occur upon docking of the receiving station 100 into a communications portal, such as the docking of a PDA at a docking station communicatively connected to the remote operation center 110, for example. Real-time communication between the at least one receiving station 100 and the remote operation center 110 may occur, for example, if the receiving station 100 is connected to the materials management system 10 substantially directly, such as by a direct connection through the external network 120. The receiving station 100 may collect the attributes, and may immediately send those attributes in real-time to the remote operation center 110 via the communicative connection with the external network 120. The collection of attributes at the receiving station 100 may be enhanced, for example, if the receiving station 100 includes an infrared scanner for scanning barcodes, thereby allowing for a scan of barcodes and an automated forwarding of the barcode data and associated attributes to the remote operation center 110. For example, the infrared scanner might scan a bar code on the item and thereby collect the item attributes, or attributes may be manually entered by an operator, such as for an automatically scanned barcode. Once the terminal associated with the scanner receives the attributes, the attributes may be distributed to the materials management system 10, such as by transferring to the remote operation center 110.

Alternatively, real-time communication may not be available, such as due to the environment, location, a network outage, or other event that prevents connection of the receiving station to the remote operation center 110. In such an instance, the attribute information may be batched and transferred subsequently. For example, the receiving station 100 may operate locally to batch the tracking data for transmission at a later time. This later time is preferably a time at which the conditions preventing transmission are no longer present. The batch may be downloaded upon allowance of transmission, such as by docking, as discussed hereinabove. For example, the receiving station 100 may be a handheld unit, such as a PDA, with no infrared or radiation transmission capability, and thus a direct electrical connection, such as docking, may be used to upload batched information.

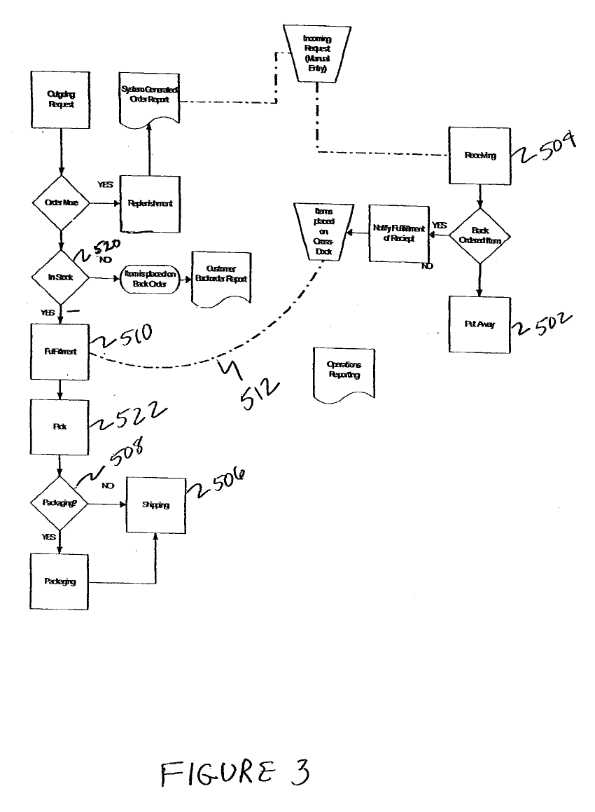

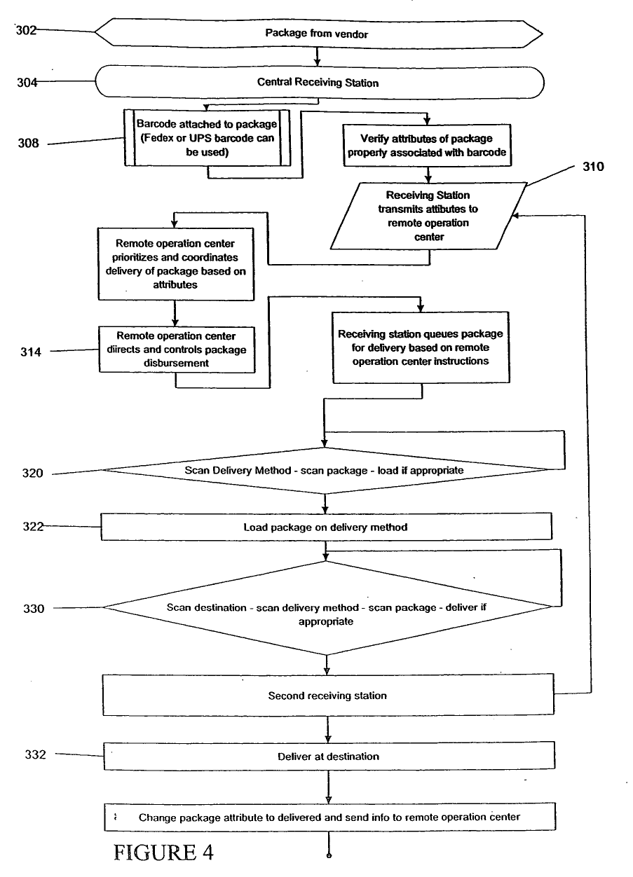

In light of the fact that the remote operation center 110 may serve to house a database of data relating to the items within the materials management system 10 received at the receiving stations 100, a plurality of reports may be generated from the database, either by the remote control center, or by a communicative connection of the remote control center to a report generator, such as a report generator at a receiving station. Reports may be generated for any number of recorded variables in the tracking system, as discussed further hereinbelow with respect to FIG. 4. Report generation may be customizable based on client desires and needs, for any or all of the attributes tracked within the materials management system 10. For example, the quantity of items arriving at a given destination can be reported, and this report may additionally include the time at which the packages were delivered. Reports may be generated, for example, to isolate an error source in the distribution sequence. This may be accomplished by generating error reports based on delivery stations, and by ranking the stations according to the number of errors reported. Reports may be generated to isolate a particular type of delivery. For example, perishable deliveries may be reported, and timing information can be generated for time required to get the perishable item to the destination, or timing information can be generated illustrating the average delivery time for such perishables. In addition, the attribute record may provide reports regarding usage statistics for a route and/or a truck on a route, for example, thereby providing for modifications to improve efficiencies throughout the receipt and delivery process. Reports can be generated to provide specific information about computer deliveries, chemicals, or for any recorded variable for which the client desires a report. Recorded variables can be combined in reports to provide further information.

Reconciliation may be performed using the receiving stations 100 and the remote operation center 110 in order to ensure accuracy of delivery. Reconciliation, for example, may be performed at several points in the present invention, or may be performed solely upon delivery. Reconciliation is performed based upon the attributes transmitted to the remote operation center 110, or, for example, based upon the batched data held at the local station. For example, a truck loaded with items arrives at a first destination receiving station 100, and the first destination, the truck, and the item are scanned in a predetermined order. If the scanned item is properly on the truck, and is properly delivered to that scanned first destination, the item is removed from the truck by the operator, and the status of that item attribute is modified to “delivered” status, either within the remote operation center 110 database, or, if the receiving station 100 is unable to transmit the information at that time, within the batch. However, if delivery was improperly attempted at an incorrect destination, the receiving station 100 would alert the deliverer that the current destination is incorrect, thereby allowing the deliverer to return the item to the truck to be delivered correctly. Similarly, verification can be performed that all items destined for a certain destination, or on a certain delivery run, have been properly delivered, either by the PDA or reconciliation with the remote operation center 110, or locally on the receiving station 100 with batching to the remote operation center 110. For example, a batch of proper deliveries can be downloaded to the receiving station 100, and, as each delivery is made, the batched delivery information may be checked against the downloaded list.

The materials management system 10 may additionally include a proxy server 130 between the receiving station 100 and the external network 120, and/or between the remote operation center 110 and the external network 120. This proxy server 130 is an intermediate link that intercepts and/or manipulates requests to and from the remote operation center 110, rather than transmitting those requests directly to the remote operation center 110, such as for security purposes. Consequently, each receiving station 100 may need to grant access to the remote operation center 110 to that receiving station 100 via the proxy server 130 of the network to which that receiving station 100 is connected.

The system of FIG. 1 may additionally operate using known types of paper manifests, such as, for example, in instances wherein the item is delivered on short-runs, wherein a signature is required, or during periods of computer outages. When the system, or a portion thereof, is operated using paper manifests, several modes of operation may exist. For example, the manifest may have thereon, or may have entered into the system therefor, a bar code representing a programmed set of the attributes associated with the item or items in the manifest. This enables a receiving station 100 that has not previously downloaded, from the remote operation center 110, the information associated with an item, to operate similarly to a receiving station 100 that has received the information. For example, each manifest item may have multiple bar codes printed therefor. The manifest items may each have, thereon, a bar code which is scanned upon delivery to a receiving station, and the delivery manifest carried by the delivery operator may have placed thereon a second barcode label, thereby providing the receiving station 100 with a portion of the information relative to that or those manifest item(s), such as the delivery of those items to a final destination, merely by scanning the barcode from the manifest upon return of the manifest to the remote operations center, or to a terminal communicatively connected thereto. Additionally, if the manifest information, and the attributes associated with a particular scanned item, match, then the item may be initiated to the system, and the scanning process may be repeated for each scannable line item on the manifest received at the receiving station 100. Further, upon completion of the entry of each item to the system, the manifest may be scanned, or manually entered, thereby allowing the attributes for each item to be transmitted to the remote operation center 110, as discussed hereinabove. Moreover, the packing slip of the package may have an additional copy of the barcode placed thereon upon receipt of the package into the material flow system, thereby allowing for a package to be monitored at check-in, during flow, and upon delivery using three copies of the same bar code.

Alternatively, the manifest may have listed thereon all of the items contained on a truck, and the destination for each item. As items are delivered, the manifest can be checked, either manually or automatically, to verify the delivery. Upon completion of the deliveries, contact with the materials management system 10 may be established to allow for entry of the completed manifest into the materials management system 10, thereby allowing for reconciling, completion of the delivery cycle, and an updating of the materials management system 10 records.

The remote operation center 110 may provide additional features to the local receiving stations 100, such as operator alerts. For example, when scanning items within the materials management system 10, operators may not be located near the receiving station 100, such as an instance wherein a portion of the receiving station 100 is a desktop personal computer communicatively connected to a relatively remote infrared scanner, such as a radio hand-held scanner, operated by the operator. In such an instance, it is contemplated that the present invention include color and/or sound alerts that alert the operator of specific facts. For example, when an item is scanned, the screen of the PC to which the item is scanned may flash the color blue to alert the user that the information has been accepted and entered to the remote operation center 110. Alternatively, the screen may flash red to alert the operator that the item, scan, or entry is not acceptable, or must be manually overridden.

In an exemplary embodiment of the materials management system 10, an interface exists between the at least one receiving station 100 and the remote operations center 110, over an external network 120 and through a proxy server 130. The receiving station incorporates a scanner, such as for example, a handheld wireless scanner, such as an SPT 1733 Handheld Wireless Scanner, or a wired scanner, such as a Symbol SPT/F100, to allow for package, and package attribute, tracking. In this exemplary embodiment, material flow through the materials management system is initiated as an order with a supplier. The record of the order, including the attributes of the item, is entered into the system via a computer linked to the at least one receiving station 100, such as by making use of the copy link 140 to copy a supply order from the local computer to the remote operations center. Upon receipt of the ordered item at the at least one receiving station 100, a bar code label is associated at the remote operations center with the attributes of that item, and the bar code label is printed and affixed to the item. This barcode thus represents the attributes of that item in the materials management system 10. In addition, the attributes, namely receipt of the item at a first of the at least one receiving stations 100, are updated as updated attributes of the item.

With reference to the exemplary embodiment, after bar coding, the item may flow to the distribution area, whereat the item is scanned and designated for delivery in accordance with the item attributes. For example, delivery via a truck might entail scanning the bar coded item and the matching of a scan of a bar coded truck, as discussed hereinabove. The item, now reconciled to the proper delivery truck, might then be loaded onto that truck for delivery to the destination. Off-loading to a building might then be performed by scanning the bar coded item and then matching a scan of a bar coded building. The quantity of packages delivered to the building, and the number of items destined for that building, may be compared with the attributes of the items as stored at the remote operations center, as determined either by a continuous communication between the scanner and the remote operations center, or by a batch of information accessible to the scanner, to provide for a reconciliation to ensure accuracy in delivery

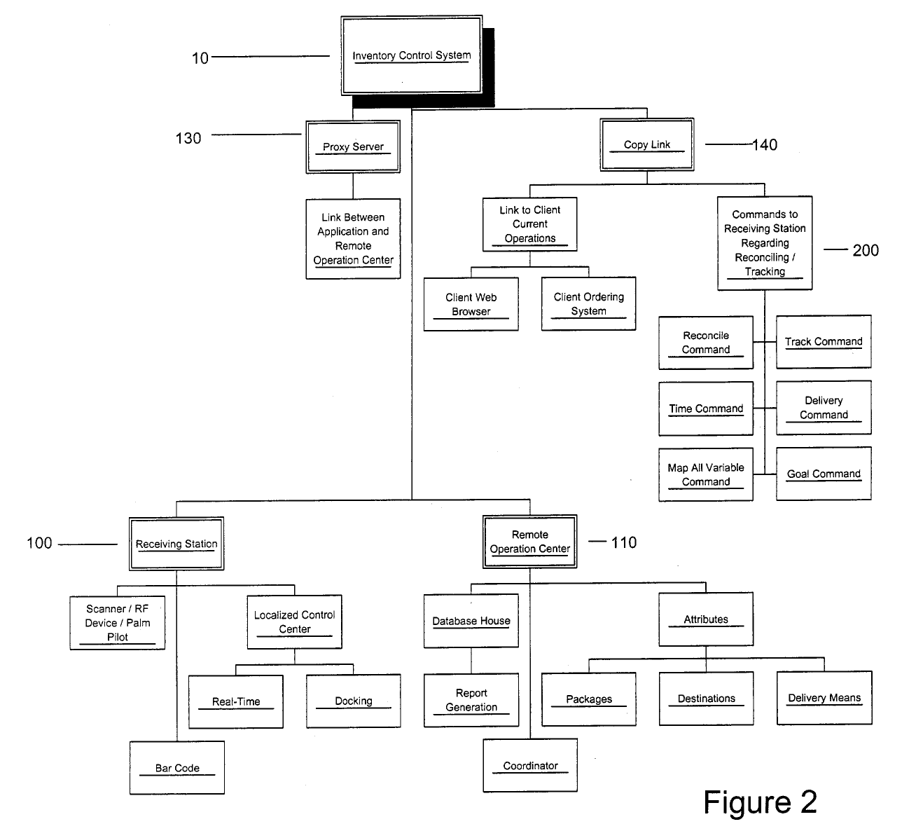

FIG. 2 is a block diagram illustrating, with more particularity, an embodiment of the system of FIG. 1. The system of FIG. 2 illustrates the inclusion in the system of at least one receiving station 100, the remote operation center 110, and at least one copy link 140. FIG. 2 additionally illustrates that the copy link 140 of the present invention may provide the capability to generate commands for reconciliation and/or tracking 200 at the copy link 140 station, and to download those commands 200 to the remote operation center 110 via the receiving station 100.

In an additional specific exemplary embodiment of FIG. 1, described more fully with respect to FIG. 3, a catalog of products to be tracked by the materials management system may be provided. The cataloged products may preferably be reviewed in order to insure available housing in a selected warehouse. This reviewing may be automated or manual. Upon receipt of the catalog of products, and prior to the warehousing of any products so cataloged, allocation attributes for primary and/or secondary put-away locations for put away 502 in the warehouse facility associated with the system may be automatically assessed, such as by review of available put-away locations, and matching of product size and/or type, and/or originator, with available put-away locations for put away 502. As used herein, the materials management system may be remote from the warehouse, and may be connected by a network, such as a wireless network, an internet, or an intranet, as discussed hereinthroughout.

A plurality of data, such as a plurality of product data points, i.e. the attributes as set forth herein, such as tracking SKU#, vendor SKU#, customer SKU#, vendor code, item description, customer, default carrier, quantity, lead time, vendor contact, express flag, perishable flag, hazardous flag, handling or shipping flag, cleanup instruction, primary or secondary put away locations, effective date, or physical dimensions, may be collected and entered at receiving 504 with regard to each of the catalog of products, in order to facilitate the allocation of the products upon receipt at the warehouse, such as upon receipt at a receiving station. For example, an allocation attribute may include whether the product may be packed or shipped at shipping 506 as is, or whether assembly is required, or whether multiple pieces, or whether additional packaging is required 508, or multiple boxes are required.

Following storage at the warehouse facility in accordance with the allocation, customer orders may be accepted and/or received. Customer orders may be those orders that request the accessing of a product from a put-away location for fulfillment 510, and the shipping 506 of the product to a specified customer. Customer orders are preferably tracked and/or entered into the logistics tracking system at a receiving station. Upon accessing from the put-away location, customer ordered items may flow to a fulfillment receiving station 512. Customer order items include a plurality of data that is entered into the fulfillment system at 510, such as the size and weight of the item, the tracking number, and one or more selected from the list of customer order data attributes, such as client, order number, tracking order number, ship to or from, ship method, ship date, delivery date, carrier, and/or one or more line item data attributes, such as order number, client number, line item number, line number, client or tracking SKU, quantity ordered, ship instructions, pallet number, weight, or the like.

Following put-away, alternatively, vendor orders may be received, wherein the future delivery of goods is alerted to the warehouse. It will be apparent to those skilled in the art that customer and/or vendor orders may be entered locally or remotely, such as by a network interface, such as over the Internet. Vendor orders are forwarded to a receiving station, to thereby allow the materials management system to control the workload at receiving stations. This tracking control at receiving stations may be performed manually, or automatically. A received vendor order may include a plurality of vendor order data points, similarly to customer ordered data points and log-in item data points discussed herein.

The receiving station system provides the materials management system with updates of upcoming activity, and the receiving flow of goods. In a preferred embodiment, barcodes, or other identifying material, may be attached to received goods upon receipt at a first receiving station, in embodiments wherein received goods do not already have present thereon barcodes or similar identification. Barcodes may then be associated in the tracking system with the series of data point attributes, as discussed herein. Receiving stations may be operated or defined locally, or remotely, such as via remote access terminals.

The put-away system puts goods in a location allocated through the allocation methodology described herein, following receipt at a receiving station. Put-away may be done manually, or automatically, and put-away assignment may be preferably done automatically. The put-away process preferably includes scanning of the barcode or identifying item placed on the product at the receiving station, in order to record the put-away.

Following allocation put-away, and receipt of an order, fulfillment may occur. Fulfillment 510 preferably includes the accessing of the product to a fulfillment receiving station from the allocated put-away location, and the use of the retrieved item to fulfill a customer order. Fulfillment is preferably tracked through the use of tracking of the barcode or identifying item placed on the product at the receiving station. Fulfillment preferably automatically causes the association of a plurality of data point attributes with the item used for fulfillment, such as discussed herein. Fulfillment may occur in accordance with a pick operation that assesses the proper allocated item to be used for fulfillment, and whether that item is present and available 520. Each of the receiving, put-away, and fulfillment operations, including the pick operation, may have available thereto a batch capability, wherein a plurality of data not immediately accessible to the tracking system may be batched for later download, such as on a remote scanner, personal digital assistant, or any other remote device that may be connected via, for example, a modem that may require access to adequate signalling in order to send the data to the tracking system. Alternatively, any data may be typed in, or otherwise manually coded in, such as at a terminal associated with a receiving station in the receiving, put-away, fulfillment, and/or picking functions.

The picking 522, which may be performed automatically or manually as part of the fulfillment process, may include the locating of the correct item for fulfillment, such as by providing a scanning capability to access the correct item from a variety of put-away locations. In a preferred embodiment, upon scanning, an alert that the proper item has been picked will automatically be generated by the materials management system, in an embodiment wherein the materials management system has access to the picking receiving station.

Orders and items selected for fulfillment, may proceed to packaging receiving stations. Items not requiring packing may be directed a shipping station without passing through a packaging station. Receipt at a packaging station will preferably cause a plurality of packaging data point attributes to be associated with the barcodes or other identifying item on the picked product. Following packing, or directly in an embodiment wherein packaging is not necessary, the item may proceed to a shipping receiving station. Shipping, or otherwise handing off an item, such as for delivery, will cause the association with the package of a plurality of shipping data point attributes in the materials management system, as set forth herein.

FIG. 4 is a flow diagram illustrating an exemplary flow of the tracking system of the present invention. The method of FIG. 4 may include the steps of receipt of an item from a vendor 302 at a central receiving station 304, attaching a barcode or entering a preexisting barcode to the system 308, the transmission of attributes associated with the barcode to the remote operation center 310, receipt of remote operation center instructions for item delivery in accordance with the attributes 314, scanning the delivery methodology 320, loading the item for delivery 322, scanning a destination, and delivering if appropriate 330, and delivering to a scanned destination 332.

In operation, an item typically arrives from a vendor, such as via a mail carrier, package carrier, courier, or the like, at a central receiving station. Items received at the receiving station 100 may or may not already have a barcode placed thereon by the sender, carrier, or courier. Upon receipt in the central receiving area, an item without a barcode thereon may preferably have generated a barcode, which barcode is attached thereto. The barcode, whether already present on the item, or placed thereon at the receiving station 100, may be associated within the system 10 with basic attributes of that item, such as sender, size, or the like, such that scanning of the barcode will reference the necessary attributes of the item within the materials management system 10. Thus, the present materials management system 10 may generate barcodes at the receiving station 100, which barcodes are associated with attributes, or may employ barcodes of common deliverers, such as UPS® or FedEx®, for association with attributes. The entry of attributes associated with the item via the barcode may be verified by the operator following entry, either manually or automatically. For example, the barcode may be scanned, and the attributes of the item may be displayed at the receiving station 100 in response to the scanning, for review by an operator, or for automated comparison, such as between an actual weight and an attributed weight. Further, an operator providing verification may additionally be provided a capability to enter additional information not appearing in the attribute record.

Upon verification of the attributes for the item, the data record is sent from the receiving station 100 to a remote operation center 110. The remote operation center 110 prioritizes and coordinates delivery of the item, based on the attributes of the item and the master prioritization of the materials management system 10. For example, perishable goods may receive maximum priority within the design of the materials management system 10. The remote operation center 110 controls disbursement and/or flow of the item by updating and/or modifying the attributes to reflect desired flow and delivery mechanisms, timing, and conditions, such as the conveyer upon which the item must pass to reach a particular truck that delivers that specific item type, or that delivers to that particular assigned end-destination at a given time. Upon receipt of a command from the remote operation center 110, the receiving station 100 may queue the item for delivery using these modified attributes as a guide. Throughout the process flow, instructions from the remote operation center 110 are associated with the item as updated or modified attributes. As delivery methods are performed in accordance with the attributes, the delivery methodology and location may be scanned, as well as the delivered item. For example, the scanning of a bar code on a truck that is to complete delivery of an item, followed by the scan of an item taken off that truck, may be performed to thereby inform the system that the truck was the selected delivery method for that item, and that the truck is attempting to complete delivery. If the remote operation center 110 has designated this delivery method for that item, the item may be properly loaded onto this delivery method.

Upon verification of the delivery method, either using confirmation from the remote operation center 110 of the selected delivery methodology, or by a manual override, for example, the associated delivery method may perform the delivery process. As delivery is performed, each end destination may be scanned, in addition to the scanning of, for example, the delivery methodology and the item delivered. Upon scanning of the destination for this item, the item, and the delivery methodology, the remote operation center 110 will select whether this item is properly delivered by this methodology to this destination at this time, and the operator may be informed of this reconciliation, such as by a hand-held unit, either in communication with the remote operation center 110, or by batched information stored on the hand-held device during a prior docking communication of the hand-held with the remote operation center 110. Reconciliation may be used to ensure that the then-present destination is not departed by the operator without delivering a particular item, or after having mis-delivered a particular item. A particular destination so scanned and/or reconciled may be the final destination for the item, or may be, for example, a secondary receiving station 100. If the particular destination is a secondary receiving station 100, the process discussed hereinabove may be repeated. Once an item reaches its ultimate destination, the attributes of that item would preferably be modified to reflect a “delivered” status, and this modified status would be updated throughout the materials management system 10, including at the remote operation center 110.

The present invention tracks and reconciles package inventory over the internet, or over any external network 120, at the remote operation center 110. Consequently, monitoring and control of inventory and process flow are made available in the present invention from any access point to the external network 120. For example, tracking is performed at a local station, is recorded, monitored, and modifiable at the remote operation center 110, and the remote operation center 110 is accessible and modifiable in its control of the local station by external network 120 access to the remote operation center 110. In this manner, process controllers can control and monitor process flow from any point at which access to the external network 120 is available, such as from a business travel location, or from the home of the process controller.

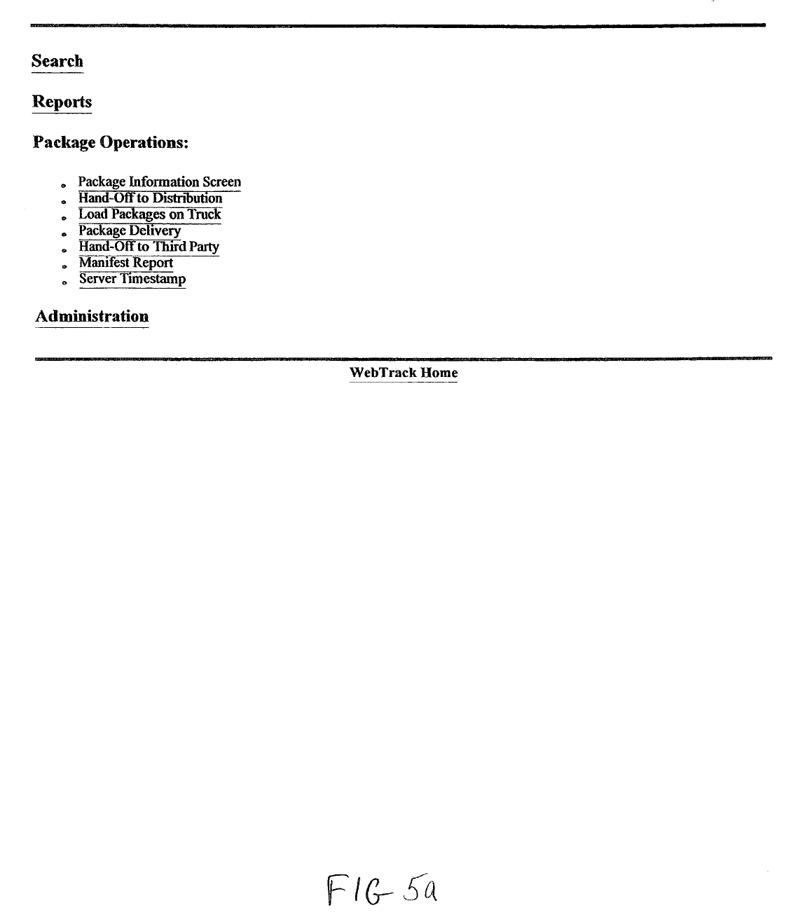

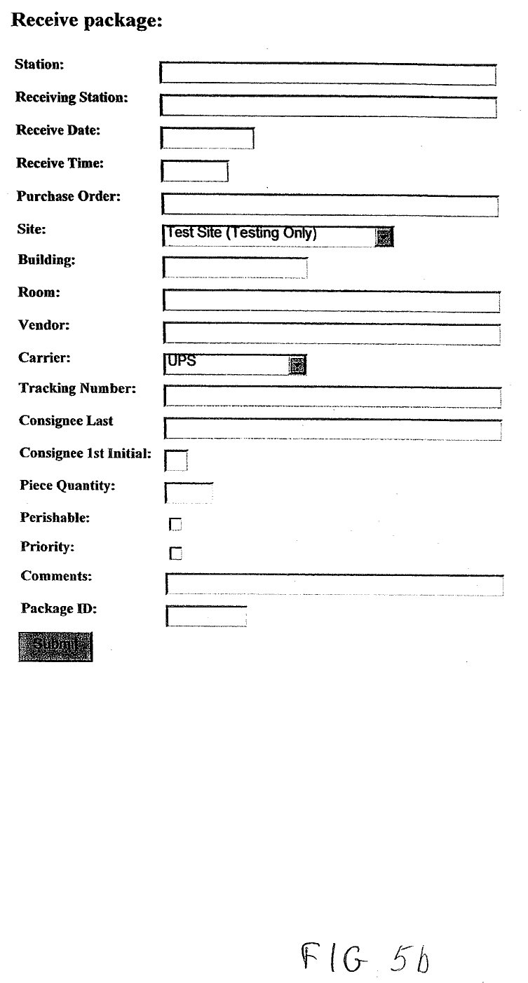

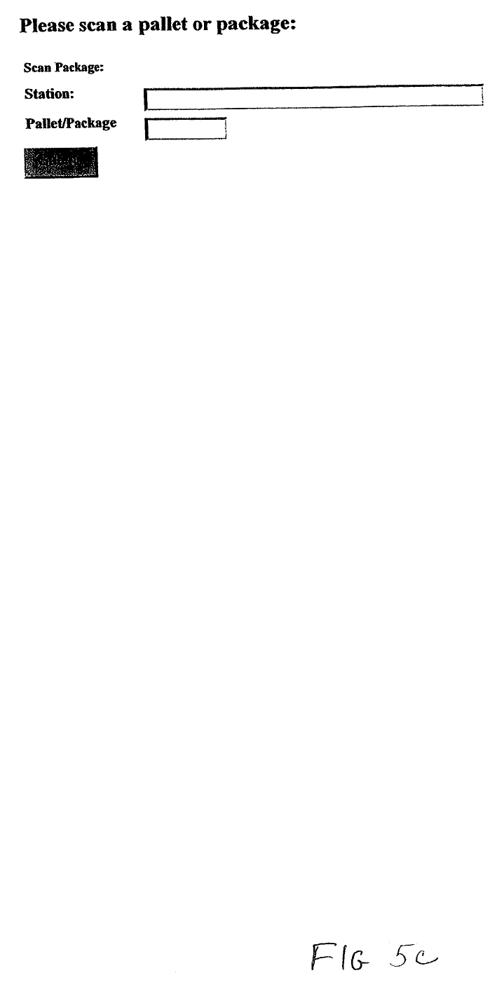

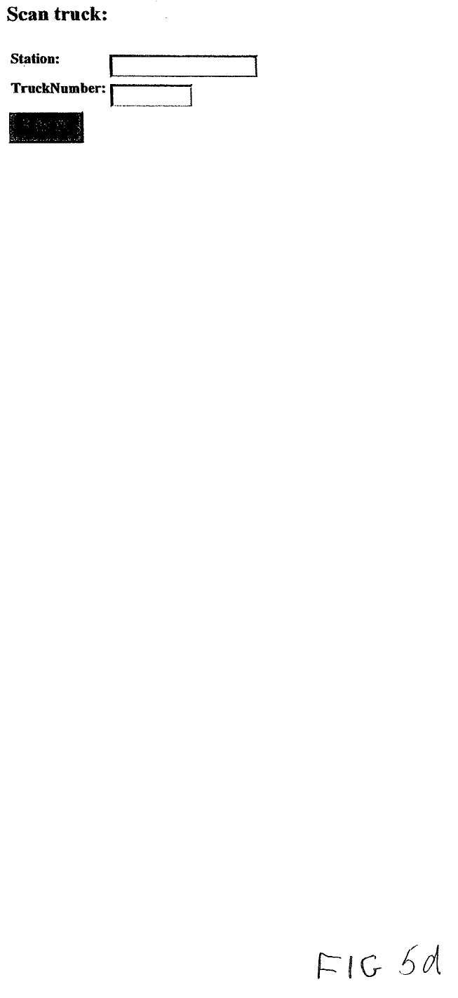

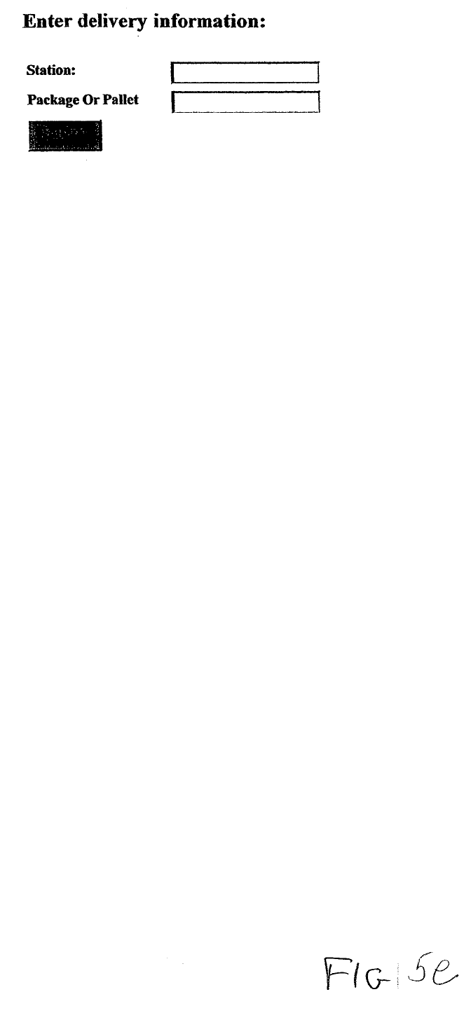

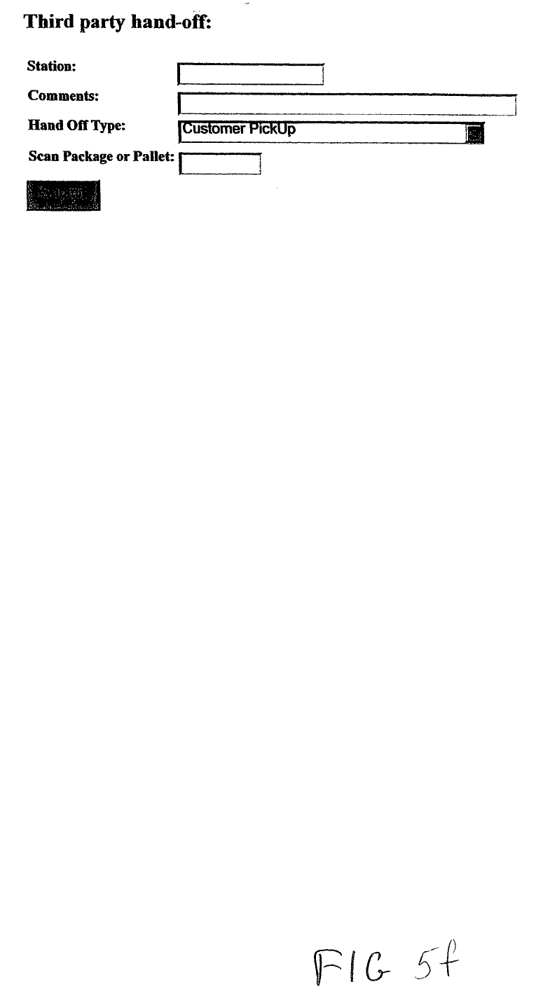

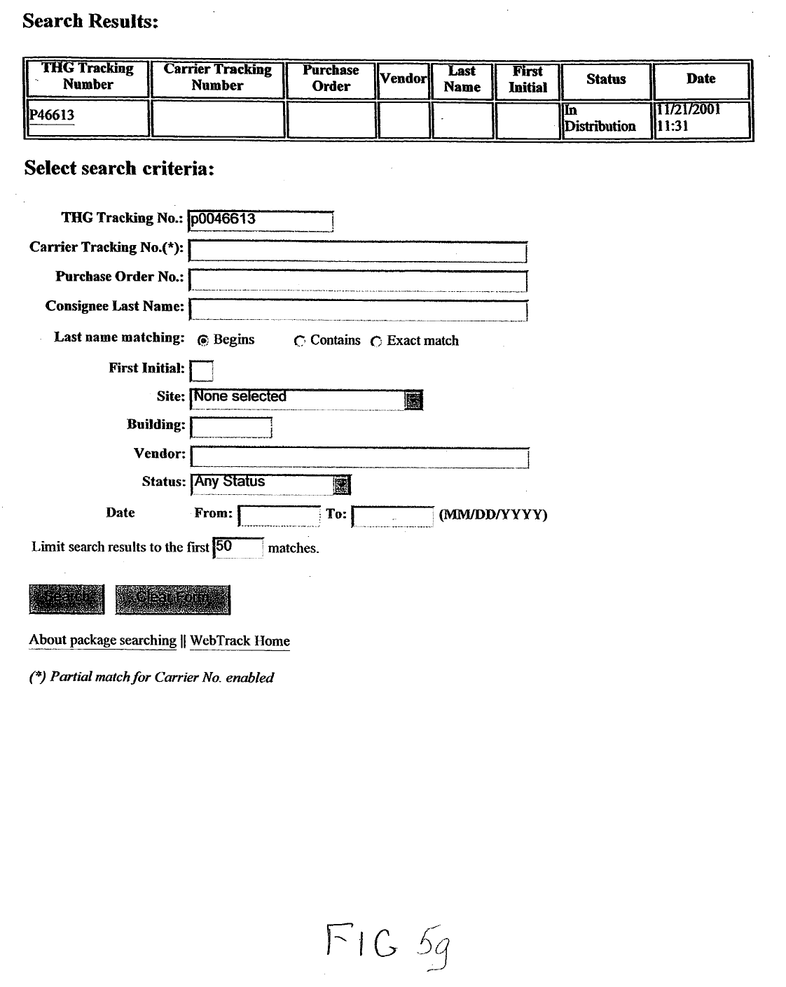

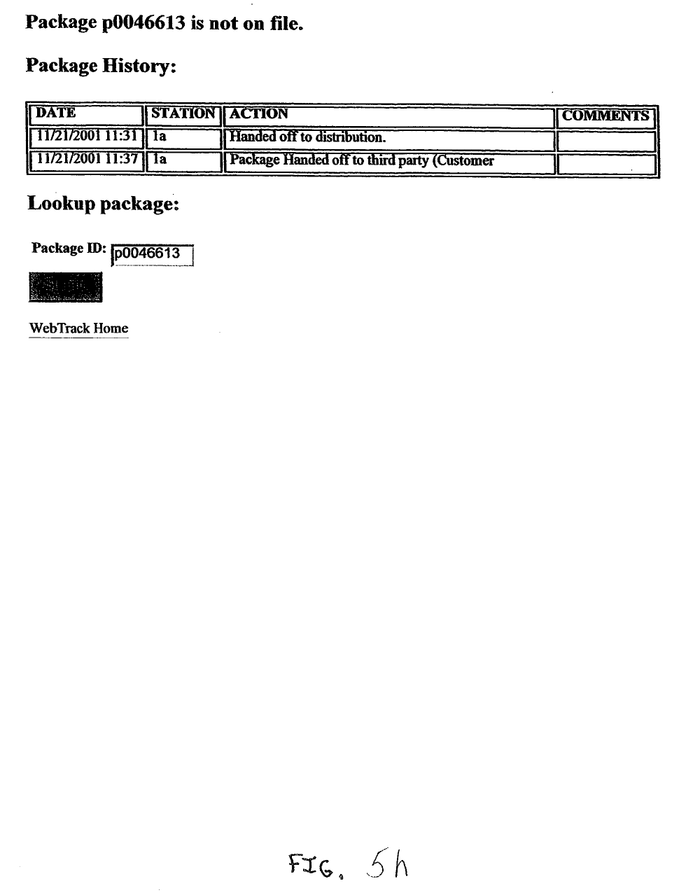

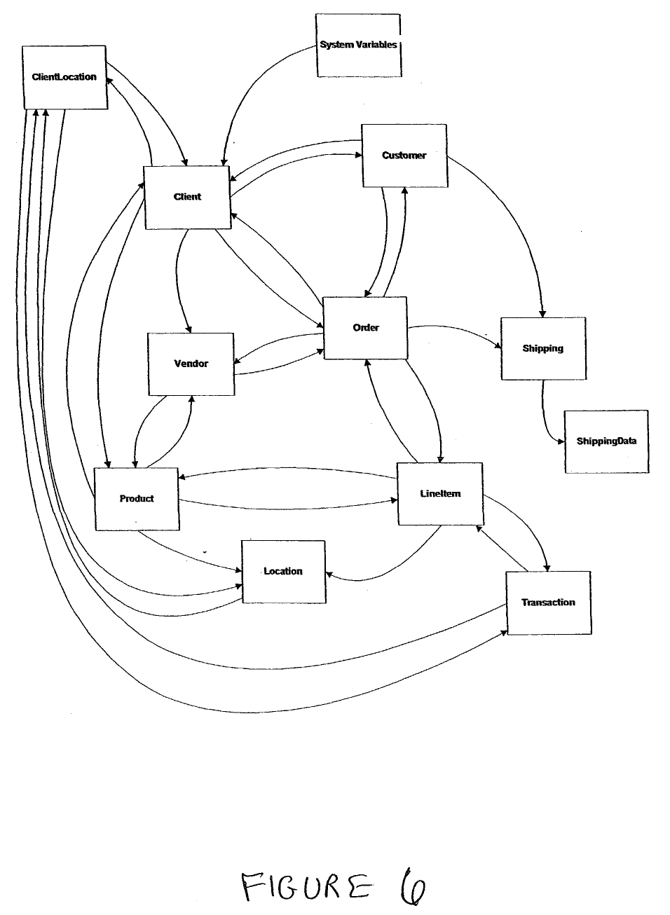

FIGS. 5a through 55h illustrate an exemplary user interface that may operate in conjunction with the method and system of the present invention.

FIG. 5a illustrates the front page of a tracking system in accordance with the present invention, which front page is accessible via a network interface. In one embodiment of present invention, the screen illustrated in FIG. 5a may be one portion of a split screen representing the remote operation center 110, wherein a second portion of the split screen may be a display of data items within the local, and/or legacy, system at the receiving station 100. By this methodology, information in the local portion of the split screen may preferably be highlighted, or otherwise copied, such as by an operator or an automated information seeker, for pasting into the portion of the screen illustrating the remote operation center 110 for the tracking system. This information may be copied from the local portion to the remote portion simply by hitting, for example, a “submit” button.

The front page of the remote operation tracking system accessible over the network preferably includes options for the user to select from. In an exemplary embodiment, these options may include, for example, information on a particular item, hand-off options for a particular item either to distribution or a third party, loading options for an item, delivery options for an item, and/or reporting options for an item. Also included, may be, for example, search options, or administration options, for either the local system or the remote system of the present invention.

For example, within the local system, an item may be earmarked as received, or not received, and may include a tracking number, or may not include a tracking number. If the item has been received, the item information will be accessible via a received item record, such as that illustrated in FIG. 5b. The received item, in an embodiment wherein the received item does not have a pre-assigned bar code, may have a bar code generated for it from the remote operation center 110, and this bar code may be sent to, and printed at, the local station, for placement onto the item. Upon receipt of the bar code, the item may be tracked using the information illustrated in FIG. 5b. For example, the attributes of the item preferably include the tracking number, which may be the bar code number, the station at which the item was received, the date and time of receipt, a purchase order number, if available, a delivery site, which might include a building and room, a vendor, or sender, a carrier, if applicable, and other attributes unique to the received item. In an embodiment of the present invention, this information is accessible only to persons that log in to system, such as with an acceptable username or password. In another embodiment, portions of the information may be made available without such restricted access.

Upon display of the item information, an operator at the local station may have an option to enter any information, or attributes, not then-present in the information available from the remote operation center 110. In an embodiment wherein a bar code has already been assigned, either by the deliverer or by the remote station, the item may be scanned as illustrated in FIG. 5c. A scan screen similar to that in FIG. 5c may be employed at each receiving station 100 point in the materials management system process, to provide the capability to scan the item, and check attributes, at each point in the materials management system. Further, as illustrated in FIG. 5a, hand-off is available upon scanning at the receiving station 100, such as to the internal distribution operation center of the receiver of the item, or to a third party, such as a common carrier, as discussed hereinabove. In a preferred embodiment, the item is scanned at the station at which hand-off occurs, thereby entering into the remote operation center 110 the information that the item has been handed-off.

The search option, such as that illustrated in FIG. 5a, allows the item to be searched for using any unique attribute, at any point during operation of the tracking system. For example, if an item has been scanned as handed-off to the distribution operation center, a search for that item by tracking number will generate a status such as “in distribution”. Further, the most recent station at which that item has been scanned will be available via the search option. Once the item, and its location, are generated using the search option, the movement of an item can be effected pursuant to entry into the item attributes by an operator of movement information specifying the different location, or station, for that item.

As illustrated in FIG. 5a, a “load to truck” option may be available as a delivery option for an item in the tracking system. It will be apparent to those skilled in the art that numerous other delivery options may additionally be available, such as via train, forklift, airplane, or other delivery methods apparent to those skilled in the art. If an item is to be loaded to the truck, the truck may be scanned, as illustrated in FIG. 5d, or information concerning the delivery vehicle may be hard coded into the system fields. The truck onto which the item was loaded, the station at which the item was loaded onto the truck, and a date and time stamp for loading onto the truck, are preferably recorded into the attributes of the given item as illustrated.

Upon delivery of the item, a “package delivery” option may be selectable from FIG. 5a. Selection of this option allows for confirmation that the item has been received, and submitted into the system at the station at which the item was received. For example, delivery information may be entered into a screen as illustrated in FIG. 5e. Information may be entered to FIG. 5e by a scan of the item at the delivery location, or by manual entry using at least one attribute of the item, such as the bar code number. In accordance with FIG. 4, information on an item is available via the item attributes at each point in the delivery process, and it will be apparent to those skilled in the art that any number of stations may be present along the delivery process. For example, numerous automated scan stations may be available within a plant, for example, and each scan station may scan the bar code of the item, and thereby update the item attributes within the tracking system. Thus, the present invention allows for an updating and tracking of item attributes throughout all steps of a materials management process, rather than simply at the beginning of the process and at the end of the process as is known in the prior art.

FIGS. 5f and 5g illustrate exemplary item “searches”, wherein a single unique attribute of the item has been entered, and the attributes of the item are generated therefrom. FIGS. 5g and 5h illustrate that the attributes of an item are updated as each station in the system is passed, and as each action is taken on the item throughout the system.

Further, as illustrated in FIG. 5a, reports are available using the present invention. For example, a manifest report may be available for use by the operator of a delivery vehicle. The manifest report, may be, for example, keyed by bar codes of the items placed on the truck. Thus, upon delivery of each item on the truck, the bar code of the item can be checked against the manifest, and, upon completion of the delivery of all items on the truck, the manifest report will have zero number of items remaining for delivery. Thereby, the manifest report may be manually updated, or may be automatically updated by matching the delivered items at a handheld device, or by communicating from a handheld device with the remote operation center 110 via, for example, a wireless modem, or a docking station. Additional reports may be available, such as reports on number of deliveries to a particular delivery point, such as a building, or address, or reports on particular runs, such as the types of items on a delivery run, or the division of items on different delivery runs, or different delivery methodologies, such as by delivery truck, or forklift. Reports are preferably customizable, and may be customizable over the network interface with the remote operation center 110.

FIG. 6 is a topographical diagram illustrating certain of the inter-relations of a computing database which may be employed in the materials management system.

Those of ordinary skill in the art will recognize that many modifications and variations of the present invention may be implemented. The foregoing description and the following claims are intended to cover all such modifications and variations.

We claim:

1. A materials management system, comprising:
a selected warehouse;
a plurality of cataloged products, wherein each of said plurality is received and is reviewed in order to insure available put-away locations for each of the plurality in said selected warehouse, wherein the review comprises assigning data point attributes to each of said plurality;
a customer order receiver, wherein said customer order receiver compares ones of said data point attributes to at least one order data point; and
a fulfillment station that accesses ones of said plurality from the selected warehouse in accordance with the comparison, wherein the accessing comprises reading a bar code having associated therewith said data point attributes, and wherein the accessing comprises an updating of said data point attributes by the reading of said bar code.

2. The system of claim 1, wherein said data point attributes are selected from the group consisting of a tracking SKU#, a vendor SKU#, a customer SKU#, a vendor code, an item description, a customer, a default carrier, a quantity, lead time, a vendor contact, a express flag, a perishable flag, a hazardous flag, a handling, a shipping flag, a cleanup instruction, a primary put away locations, a secondary put away locations, an effective date, and a physical dimension.

3. The system of claim 1, wherein said at least one order data point is selected from the group consisting of a size and weight of a product, a tracking number, a vendor, a client, an order number, a tracking order number, a ship to or from, a ship method, a ship date, a delivery date, a carrier, a line item number, a line number, a quantity ordered, and a pallet number.
